(19) United States
(12) Patent Application Publication
(10) Pub. No.: US 2013/0235701 A1
(43) Pub. Date: Sep. 12, 2013

(54) METHOD TO DELEGATE ACTIVATION AUTHORITY TO SEISMIC SOURCES DURING OPERATIONS

(71) Applicant: WESTERNGECO L.L.C., HOUSTON, TX (US)

(72) Inventors: MARTIN LAYCOCK, Asker (NO); Kevin O'Connell, Asker (NO); Sergey Koshechkin, Novosibirsk (RU); Mohamed Dehbaoui, Haslum (NO)

(73) Assignee: WESTERNGECO L.L.C., HOUSTON, TX (US)

(21) Appl. No.: 13/753,172

(22) Filed: Jan. 29, 2013

Related U.S. Application Data
(60) Provisional application No. 61/593,997, filed on Feb. 2, 2012.

(51) Int. Cl. G01V 1/147

(52) U.S. Cl. CPC G01V 1/147
USPC 367/190

(57) ABSTRACT

A seismic survey method including determining an expected time when an actuation step will be performed by a seismic source device, transmitting a signal from the seismic source device to a source control system thereby alerting the source control system of the expected time when the actuation step will be performed by the seismic source device; and in response to the signal from the seismic source device, providing a communication from the source control system to the seismic source device.

### CROSS REFERENCE TO RELATED APPLICATION

This application claims the benefit of U.S. Provisional Patent Application Ser. No. 61/593,997 filed Feb. 2, 2012, which is incorporated herein by reference in its entirety.

### TECHNICAL FIELD

The present application relates to use and control of seismic vibration sources, and more particularly to the expected/predicted timing of the seismic vibration source activities so as to reduce time in operation and to increase efficiencies.

### BACKGROUND

A principle of seismic surveying is that a source is caused to produce seismic energy that propagates downwardly through the earth. The downwardly-propagating seismic energy is reflected by one or more geological structures within the earth that act as partial reflectors of seismic energy. The reflected seismic energy is detected by an acquisition system. The acquisition system can be made up of one or more sensors (generally referred to as “receivers”). A source control system can be connected or associated with the acquisition system. The source control system may include a computer unit and/or memory. The source control system can be housed in a mobile vehicle such as a recording truck, but can be housed/located in any suitable structure. The source control system can perform functions of data collection, processing and/or vibrator control with respect to positioning and timing. It is possible to obtain information about the geological structure of the earth from seismic energy that undergoes reflection within the earth and is subsequently acquired at the receivers.

In practice, a seismic surveying arrangement can comprise an array of sources of seismic energy. Numerous sources can be used to generate sufficient energy to illuminate structures deep within the earth when a single seismic source is not able to do this best. It is also possible to use single sources (such as a single vibrator) that produce sufficient energy on their own, or to use a group and to coordinate/alternate actuation of such.

Sources can emit seismic energy at more than one frequency. Examples of such seismic sources are a vibrator. Vibrator(s) can emit seismic energy in a frequency range of, for example, from 1, 5 or 10 Hz to 100 Hz. When such a vibrator source is actuated, seismic energy is emitted over a finite time period. The frequency of the emitted energy can change during the period over which seismic energy is emitted. For example, the frequency of the emitted energy may increase monotonically during the period over which seismic energy is emitted. The process of operating a vibrator source of seismic energy to cause emission of seismic energy over the frequency range of the vibrator is referred to herein as “sweeping” the vibrator, and the step of initiating a vibrator sweep is referred to as “actuating” the vibrator. Each emission of seismic energy from a vibrator is known as a “shot.” The time period over which seismic energy is emitted by the vibrator source is referred to as the “sweep time” and the “sweep rate” is the rate at which the frequency changes over the sweep time (a linear sweep rate is generally used in practice).

A seismic vibrator source for use on land can include generally a base plate that contacts the ground. Seismic energy is transmitted into the ground by applying a vibratory force to the base plate, and this is done by applying a control waveform known as a “pilot sweep” to the vibrator control mechanism. The pilot sweep is generally constant amplitude swept frequency signal, although it tapers off at each end to allow the amplitude of the vibration to be ramped up and down at the start and finish of the sweep respectively. In practice the waveform applied to the ground by the base plate is not exactly the same as the pilot waveform; in particular, as well as applying a force at the desired frequency at any particular time (known as the “fundamental frequency”), the vibrator also applies a force at integer multiples of the fundamental frequency (known as “harmonics”).

When a seismic vibrator source is actuated to emit seismic energy, the seismic energy incident on a receiver can be recorded for a pre-determined period from the start of a sweep time of the source. The time from the end of the sweep time to the end of the recording period is generally known as the “listening time,” and data is acquired at a receiver from the start of the sweep time to the end of the listening time. The data acquired at a receiver in consequence of actuation of a source can then be processed, for example by cross-correlating the acquired data with the pilot sweep of the source to produce a record that is the length of the listening time.

In seismic surveys, a source control system can monitor and control the seismic vibrator(s). In that scenario, the vibrators provide information to the source control system concerning present location and availability of the vibrator. In response, the source control system provides instructions to the vibrator(s) to regulate their operations based on the overall activity.

An acquisition system can include various seismic sensors, e.g., hydrophones, geophones and/or accelerometers (known as recorders, receivers or listening devices). The acquisition system can be connected with the source control system. This connection can be by wire (cable) or by a wireless connection. Also, the acquisition system may not be connected with the source control system and be in a “blind” configuration. In that case, data from the acquisition system can be harvested and may be delivered to the source control system, or to other data acquisition/processing locations. Another configuration is “semi-blind,” where no seismic data is transmitted wirelessly, but quality control information is transmitted wirelessly to the source control system.

An example along these lines can be found in U.S. Patent Application Publication No. 2011/0205845 to Quigley (2011) which is incorporated herein by reference in its entirety.

An issue related to seismic surveys is the time required to complete a survey. With much iteration of vibration and listening taking place, as well as numerous sources working at once and/or “taking turns,” any time saved can be valuable. The present application addresses various issues and helps reduce the time the seismic survey takes by reducing the time of and between iterations, as well as reducing wasted steps therein.

The preceding description is meant to aid the understanding of one skilled in the art with respect to embodiments in the present application and is in no way meant to unduly limit any present or subsequent claims in connection with this application.

### SUMMARY

The following is a summary of various combinations of embodied features and is meant to aid one skilled in the art understand the present application. It is not meant to unduly limit any present or subsequent related claims associated with this application.

According to one combination of features, a seismic survey method includes detecting at least one parameter related to a mobile seismic source device, processing the at least one parameter with a processor connected with the mobile seismic source device and thereby forecasting a parameter of a future actuation step that will be performed by the mobile seismic source device, transmitting the forecasted parameter of the future actuation step that will be performed by the mobile seismic source device from the mobile seismic source device to a source control system containing, and in response to the signal from the mobile seismic source device, receiving a communication from the source control system to the seismic source device relating to the parameter of the future actuation step.

According to another combination of features, a seismic survey method includes transmitting a signal from a seismic source device to a source control system thereby alerting the source control system to at least one parameter relating to the seismic source device, in response to the signal from the seismic source device, determining with the source control system at least one expected time when the actuation step will be performed by the seismic source device, and providing a communication from the source control system to the seismic source device.

### BRIEF DESCRIPTION OF THE DRAWINGS

The following brief description of the drawings is meant to assist one skilled in the art understand the various features embodied in the present application and is in no way meant to unduly limit any present or subsequent claims associated with this application.

FIG. 1 is a side view schematic of a source vehicle.

FIG. 2 is a schematic illustrating various embodied features.

FIG. 3 is a block diagram illustrating various embodied features.

FIG. 4 is a side view schematic illustrating various embodied features.

### DETAILED DESCRIPTION

The following detailed description is meant to aid the understanding of one skilled in the art with regard to the various embodiments discussed herein. It is not meant to unduly limit any present or subsequent claims associated with this application.

Seismic exploration is used to determine characteristics of subterranean formations. Based on these characteristics, the layout of the subterranean formation can be derived to a degree and it can be evaluated/determined if various features are present, such as hydrocarbons and other valuable materials.

One way to make these evaluations is by sending seismic energy into the ground formation and listening to the returned signals. One way to generate the seismic energy is with mechanical vibrator(s). Vibrator(s) (sources) can be electrically powered or hydraulically powered machines that impact the ground with force at various frequencies. The vibrators are often fashioned as motorized vehicles that move along the ground surface from position to position. Those vibrators can travel on wheels or also travel on tracks, but any means of transportation can be used. Additionally, depending on size, etc., vibrators could be fashioned to fly, and in marine applications they could be water vessels that travel on the surface and/or sub-surface of the water. It is also envisioned that they could be manned or unmanned. Vibrators are available and used commercially by/from various companies in the seismic industry. Vibrators can operate alone, as a group, all at once, and/or they can “take turns” and operate sequentially or in coordination.

During a survey a vibrator starts vibrating and stops. The activity between the start and stop is called a sweep. In between sweeps the vibrator can travel from one location to a next location. In seismic exploration the timing of the sweep is relevant. That is especially true in situations when vibrators act as groups and/or work sequentially.

Starting a vibrator includes a step of moving the plate from an up position (base plate up for traveling) to lowering the plate into a down position in contact with the ground. This can further include moving into a “hold down position” where all or a substantial part of the vibrator's weight is supported by the plate. In operation, from the time it is instructed to move the base plate from a travel position to a down or “hold down position” can take some seconds. This lowering of the base plate, at least until it contacts the ground, can take place while the vibrator is still traveling. For example, as the vibrator approaches its destination, the uses start the actuation of the down movement of the base plate. By the time the vibrator reaches the intended destination the base plate is at or near the position in contact with the ground.

The reflections of the vibrations are listened for with sensors. These sensors (receivers) can comprise hydrophones (measuring pressure) geophones (measuring velocity), accelerometers (measuring acceleration), and/or other sensors. The magnitude of linear or torsional measured motion (velocity or acceleration) can be measured. Torsional measurement can relate to ground roll. The receivers can be connected with a source control system. The source control system can include a recording memory. The source control system can control aspects of the sources such as position, actuation, timing of position, timing of actuation, and sweep characteristics. This is primarily done by way of wireless communication from the source control system to the source (vibrator).

The received (listened to) signals are recorded, processed and evaluated to show indications of the subterranean formation. The recording can be done with the source control system, where signals are received at the sensors and transmitted to the source control system. The recordings can also be done with memory that is kept locally at the receivers, e.g., when in a “nodal” arrangement. A “nodal” arrangement can be when the receivers are not connected to the source control unit by wires or cables and instead transmit the data wirelessly or locally store the data for later collection. A “blind” nodal configuration is when there is no communication. A “semi-blind” nodal configuration is when seismic data is locally stored at the sensors and harvested, while other signals such as quality control information is transmitted to the source control unit.

The timing of the start and stop of the sweep can be relevant in many ways, e.g., noise and/or interference between sources. To efficiently perform a survey, it is valuable to know when the vibrators will be expected/predicted to take actuation steps, e.g., when the initial seismic energy will be expected/predicted to start and stop, when that resultant energy should be expected/predicted to be detected at the listening device, when the vibrator is expected to have the base plate lowered and in contact with the ground and/or in the “hold down position,” when the vibrator is expected to or predicted to arrive at certain locations such as a target (destination) position or a distance from such.

With respect to the actuation operations/steps (i.e., actions/steps leading up to and including performance of the sweep), it can be beneficial to predict/determine the timing and future events related to such ahead of time and to communicate this to the source control system. For example, when an operator instructs a vibrator plate to move from the up position to the down position (or “hold down position”), it is desirable to communicate the time when the plate will reach the down position to the source control system. When an operator instructs a vibrator plate to move from an up position to a down position (or “hold down position”) while the vibrator is traveling, it is desirable to know how long it will take from that instruction until the plate is on the ground, what location that will be, and when the plate should be actuated to arrive at the ground to meet the desired time/location. Also, as a vibrator is traveling to a destination, it is desirable to predict/determine how long it will take for (or when) the vibrator will arrive at the destination and to communicate this to the source control system.

In these regards, a vibrator can include a processor that takes at least one of these factors into account (e.g., location, actuation time, travel speed, past history, etc.,) and determines/predicts the occurrence/timing of future actuation steps/events. The processor also may take at least two factors relating to the vibrator and with the processor, make predictive calculations to predict and/or estimate the timing and/or location of future events.

With the information about the predicted and/or estimated timing and/or location of future actuation steps/events, the source control system can determine if any issues exist with the indicated timing of such future steps and the action leading up to the steps can be stopped, delayed or otherwise adjusted. For example, if it is communicated that a base plate will contact the ground at a particular future time/location (if actions go as planned), but that would interfere with another vibrators sweep (e.g., noise etc.) or otherwise be unacceptable, the process steps can be altered, delayed, and/or stopped. That can minimize performing steps that are wasting time, e.g., by moving to a destination that is no longer desired based on determined timing, lowering a base plate when contact and actuation with the ground will no longer be desirable at that specific determined time.

This determination and projection can be done dynamically during travel of the source. It can also be done once a destination is reached and the instruction for lowering the base plate to the ground and into “hold down position” is made. Any technology that can help accurate prediction may be employed. This may include but not be limited to positioning systems (satellite, radio or inertial), speed and compass systems, terrain detection/mapping or elevation modeling, and in the case of a vibroseis vehicle, systems for measuring the distance between the actuator pad and the ground. As mentioned, these actions or processes can take place dynamically during operation and/or travel. The predicted future events can be based on past actions and events, and can be determined in real time dynamically. The predicted future events can be based on present actions and events too, and can be determined in real time dynamically. Computer algorithms can be used for such predictions/determinations. These predictions/determinations can be done at the source (vibrator), where the results are transmitted to the source control system.

The source control system can also be made aware of parameters relating to what the source(s) are doing (e.g., location, speed, actions, etc.) and, rather than the determination/prediction being done at the source (vibrator), the source control system can determine/predict timing for future actuation steps based on parameters relating to the source. Based on such, the source control system may send messages to abort and/or alter source actuation steps if there are issues with the acquisition system. Similarly the source(s) can send messages to the source control system to abort actuation steps if issues arise with the source(s) or the actuation steps that are determined/predicted are not acceptable. Also, alteration of the intended actuation steps and timing of such can be instructed based on predicted/determined future timing of such.

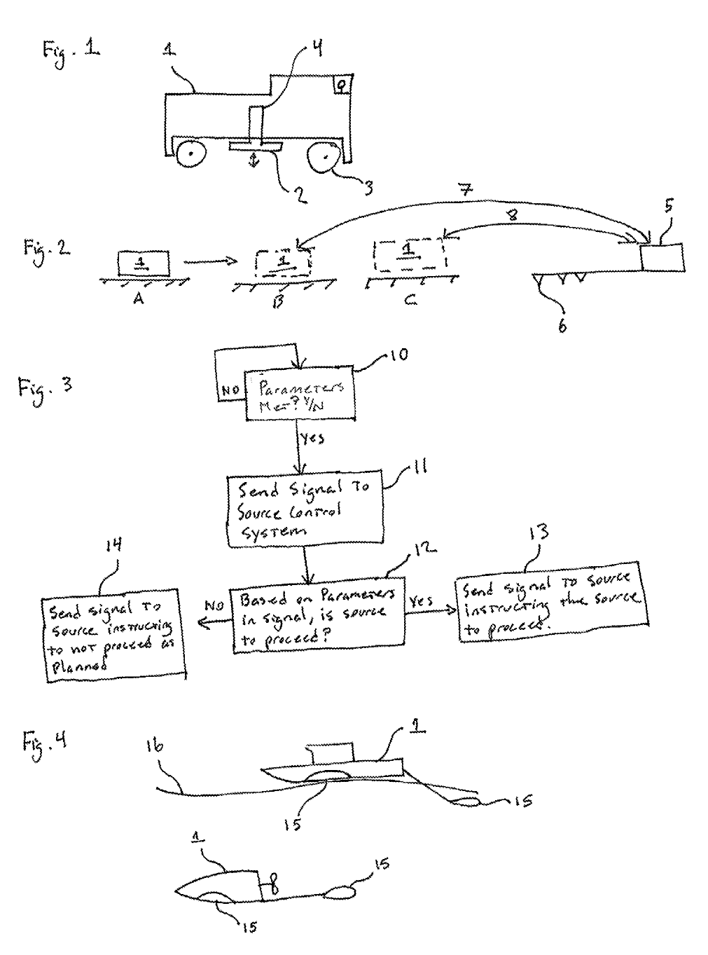

FIG. 1 shows a source 1. Here it is shown as being a vibration truck. The truck has wheels 3 (which could be replaced or supplemented with tracks), and a base plate 2 that is connected to a piston 4. The piston 4 drives the base plate 2 against the ground to create vibrations. The piston 4 can be replaced or supplemented with an electro-mechanical drive system. The source can have a memory and a processor (not shown) that can store information as well as perform processing of detected parameters, inputs and/or commands.

FIG. 2 illustrates that the source 1 can start at position A and move toward position C (target position). The position C (destination/target position) can be communicated from a source control system 5 before or during travel, and can also be stored in the source 1. Also, a plurality of different target positions, of which position C is one in this illustration, can be provided to the source 1. The various target positions can have an assigned order, or priority. The position C can be programmed or stored in memory of the source 1 ahead of time. As the source 1 moves from position A toward position C, at an intermediate position B the source 1 can communicate with the source control system 5. The source control system 5 can have acquisition system 6 connected thereto. The acquisition system 6 can be in a wired system (i.e. connected by cables), or can be in a “nodal” configuration, where each sensor or groups of sensors, are not wired together and instead rely on wireless communication to transmit data or local memory to record data. Another configuration is when local memory is used at or near the sensors, which is referred to as a “blind nodal” configuration. A “semi-blind nodal” configuration is where the acquisition system 6 has local memory for seismic data and wireless communication for other signals such as quality control or system status. Communication path 7 illustrates the communication between the source 1 and the source control system 5 at any midpoint between position A and position C. The communication path 8 illustrates communication from position C to the source control system 5. The communication can be by any known wireless system such as Wi-Fi, radio, microwave and/or satellite communications. The source 1 can communicate position, status, velocity, acceleration, target destination, intended time to target destination, terrain, etc. Based on those parameters, the source 1 can calculate/predict time before certain source activities (e.g., arrival at the destination/target, beginning of lowering of the base plate, placement of the base plate on the ground, start of vibration “sweep,” end of vibration “sweep,” etc.) of the source 1. The parameters and the predicted/determined source activities can be transmitted to the source control system 5. Once that information is received by the source control system 5, the source control system 5 can evaluate the status of the source control system 5 and/or the acquisition system 6 and determine if the source control system 5 and/or acquisition system 6 are ready for the various source activities to take place at the expected/determined future times. The source control system 5 can also determine if, based on other factors such as other sources and potential interference, if it is desired for the source 1 to proceed as planned. The source control system 5 can then communicate back to the source 1 and provide various instructions and information. The source control system 5 could communicate to the source 1 that the source should go ahead and actuate as planned. The source control system 5 can provide a time at which (or after which) the source 1 can begin actuation. The source control system 5 can provide a time window in which the source 1 can actuate. Also, the source control system 5 can tell the source 1 that it is not ready for actuation and that actuation should be delayed, aborted or altered. Further, the source control system 5 could tell the source 1 that the source 1 needs to move to a different location and repeat the process.

The communication from the source 1 to the source control system 5 at position B can be based on various parameters being met, such as distance from position C, expected/predicted time until position C is reached, the expected/predicted time before the source 1 will be prepared to actuate, a point in time being met, e.g., at 1:00 PM the source will communicate with the source control system 5, timing intervals being met, e.g., that a communication will take place every 5 minutes, and/or a change of a parameter, e.g., the change in position of the source 1. The expected/predicted time can be variable and predicted dynamically during operations. The expected/predicted time can be updated during operations dynamically as well. In this sense, predictive modeling and predictive forecasting methods and software (e.g., algorithms) can be used to make such determinations.

FIG. 3 is a block diagram that shows a decision process. The source can be traveling from position A to target position C. The source 1 could also move to a general area without specific instructions or knowledge of position C. Also, the source 1 could be already at a desired target position where travel is not needed. The position C information can be transferred or assigned to source 1 as source 1 travels, or once source 1 is in a general area. As the source 1 travels toward position C, the source 1 can interrogate to see if it has met parameters that will lead to communication with the acquisition system 5. This is represented in block 10. As noted above, one parameter could be distance from position C. Another could be expected/predicted time before arriving at position C. Another could be the expected/predicted time before actuation at position C. If the interrogation at block 10 is a negative (“NO”), the decision loops back to the initial block 10 where the various parameters are interrogated again and it is determined in any are met. However, if the appropriate parameters are met and the decision is positive (“YES”), it moves to block 11 where the source 1 is instructed to communicate with the acquisition system 5. The message along path 7 can include the expected/predicted timing of future actuation steps, e.g., future position of the source 1, the time before the source 1 will be at target position C, the time before the source 1 will be ready to actuate at position C. The expected/predicted timing of future actuation steps can be determined based on detected parameters of the source 1 with a processor that uses predictive algorithms. Where the calculations are to take place at the source control system 5, the parameters of the source 1 can be sent along the path 7 to the source 1 and the predictive calculations take place at the source control system 5.

It should be noted that the information can continually be transmitted from the source 1 to the source control system 5, and that this could also be set on a time schedule such as a transmission every minute, or every second, etc.

In block 12 the acquisition system 5 evaluates the message from the source 1 and evaluates if the source control system 5 and/or acquisition system 6 are ready for the source 1 to take the actuation steps. If the source control system 5 is ready for the source 1 to take the actuation steps and the decision is positive (“YES”), the decision moves to block 13 and the source control system 5 sends a message back to the source 1 on path 7 or 8 instructing the source 1 to continue with the expected actuation steps. The message back can include an authorization to move to position C and actuate as planned, an instruction to actuate but not until a certain time, or a window of time to actuate. The instruction can include a specific sweep sequence the source 1 is to perform.

If the source control system 5 determines that it is not desired for the source 1 to actuate as planned, the decision in negative (“NO”) and moves to block 14 where a different message is sent back to the source 1 along path 7 or 8. That message can instruct the source 1 to not actuate, tell the source 1 to bypass target position C and the associated actuation step for that position, or move toward another target position and/or to interrogate for parameters. As the source 1 moves to a new target position the same logic can be followed starting at block 10.

The source control system 5 can be not ready for a number of reasons, e.g., the source control system 5 could be malfunctioning, be actively listening to another source, be busy, the intended source plan could have been changed so that the original plan of moving to position C is not valid, or the expected/determined future actuation steps of the source 1 may interfere with other sources, or be otherwise not acceptable.

It should be noted that while these ideas herein are primarily described and focused on land applications, that they can also be applicable in marine vibration activities. For example, marine vehicles can be used to deliver the vibrators while a listening device is located on a listening vehicle. The vehicles can be manned or un-manned, and can be at surface or below surface of the water. Similarly, the sources could be unmanned land vehicles that travel on the ground or even fly between target positions.

FIG. 4 shows a marine vibrator 15 that is connected with a source 1. The source 1 can be a vessel. The marine vibrator 15 can be incorporated with the hull of the vessel. The vessel can be a manned vessel or an unmanned vessel and can be of any size. Further, the vessel can be at the surface of the water 16, or can operate below the surface of the water 16. The marine vibrator 15 can be connected to the vessel by a static connection or by a flexible towed connection. Many of the aspects discussed herein with respect to land vibrators are applicable to marine vibrators or marine sources in general. This is especially the case with respect to unmanned marine vehicles where they could operate in a group much along the lines of how land vibrators operate.

The preceding description is in connection with various embodied features of the present application and is meant to assist in the understanding of such by one skilled in the art. It is not meant to unduly limit the claim scope of any present or subsequent claims associated with the present application.

What is claimed is:

1. A seismic survey method, comprising:
detecting at least one parameter related to a mobile seismic source device;
processing the at least one parameter with a processor connected with the mobile seismic source device and forecasting at least one parameter of a future actuation step that will be performed by the mobile seismic source device;
transmitting the forecasted at least one parameter of the future actuation step that will be performed by the mobile seismic source device to a source control system; and
in response to the transmission from the mobile seismic source device, transmitting a communication from the source control system to the seismic source device, the transmission relating to the parameter of the future actuation step.

2. The method of claim 1, comprising:
at the source control system, determining if the forecasted parameter of the future actuation step that will be performed by the mobile seismic source device is acceptable.

3. The method of claim 1, wherein the mobile seismic source device comprises a vibrator having a base plate.

4. The method of claim 3, wherein the base plate is connected with a hydraulic piston that raises and lowers the base plate between a first position that is up for travel and a second position that is down and in contact with ground.

5. The method of claim 1, wherein the source control system is in communication with an acquisition system.

6. The method of claim 5, wherein the connection is by way of at least one cable.

7. The method of claim 5, wherein the connection is by wireless communications.

8. The method of claim 1, wherein the source control system is associated with an acquisition system.

9. The method of claim 1, wherein the at least one parameter related to a mobile seismic source device is at least one selected from the following list consisting of: location, time, velocity, acceleration, altitude, terrain, arrival time at a destination, time until arrival at a destination, status of actuation of a base plate, status of lowering of a base plate to the ground and into a hold down position, actuation of the seismic source device, end of actuation of the seismic source device, and system functionality status.

10. The method of claim 1, wherein the parameter of a future actuation step that will be performed by the mobile seismic source device is one selected from the following list consisting of: arrival time at a destination, time until arrival at a destination, lowering of a plate of the seismic source device, lowering of a plate of the seismic source device to the ground and into a hold down position, time of lowering of a plate of the seismic source device, time of lowering of a plate of the seismic source device to the ground and into a hold down position, time of actuation of the seismic source device, time until actuation of the seismic source device, end of actuation of the seismic source device and time until end of actuation of the seismic source device.

11. The method of claim 9, wherein the communication from the source control system to the seismic source device relating to the parameter of the future actuation step is one selected from a list consisting of instruction to: proceed as planned, move to an alternate destination, actuate at an alternate time, end actuation at an alternate time, delay lowering a base plate of the seismic source device to the ground, delay lowering a base plate of the seismic source device to the ground and into the hold down position, and an alternate sweep sequence.

12. A seismic survey method, comprising:
detecting at least one parameter related to a mobile seismic source device;
transmitting the at least one parameter related to the mobile seismic source device from the mobile seismic source device to a source control system; and
processing the at least one parameter with a processor connected with the source control system and forecasting a parameter of a future actuation step that will be performed by the mobile seismic source device;
in response to the forecast parameter of the future actuation step that will be performed by the mobile source device, transmitting a communication from the source control system to the seismic source device relating to the parameter of the future actuation step.

13. The method of claim 12, comprising:
at the source control system, determining if the forecasted parameter of the future actuation step that will be performed by the mobile seismic source device is acceptable.

14. The method of claim 12, wherein the seismic source device comprises a vibrator having a base plate.

15. The method of claim 12, wherein the source control system is in communication with a series of seismic sensors.

16. The method of claim 15, wherein the connection is by way of at least one cable.

17. The method of claim 15, wherein the connection is by wireless communications.

18. The method of claim 12, wherein the at least one parameter related to a mobile seismic source device is at least one selected from the following list consisting of: location, time, velocity, acceleration, altitude, terrain, status of actuation of a base plate, status of lowering of a base plate to the ground and into a hold down position, status of actuation of the seismic source device, fu and system functionality status.

19. The method of claim 12, wherein the parameter of a future actuation step that will be performed by the mobile seismic source device is one selected from the following list consisting of: arrival time at a destination, time until arrival at a destination, lowering of a plate of the seismic source device, lowering of a base plate of the seismic source device to the ground and into a hold down position, time of lowering of a base plate of the seismic source device, time of lowering of a base plate of the seismic source device to the ground and into a hold down position, time of actuation of the seismic source device, time until actuation of the seismic source device, end of actuation of the seismic source device and time until end of actuation of the seismic source device.

20. The method of claim 12, wherein the communication from the source control system to the seismic source device relating to the parameter of the future actuation step is one selected from a list consisting of instruction to: proceed as planned, move to an alternate destination, actuate at an alternate time, end actuation at an alternate time, delay lowering a base plate of the seismic source device to the ground, delay lowering a base plate of the seismic source device to the ground and into the hold down position, and an alternate sweep sequence.
